(19) United States
(12) Patent Application Publication
(10) Pub. No.: US 2024/0001357 A1
(43) Pub. Date: Jan. 4, 2024

(54) PIPETTE AND PIPETTE AID WITH A TWO-SYMBOL CODING

(71) Applicant: Integra Biosciences AG, Zizers (CH)

(72) Inventor: Christoph Philipp, Bad Ragaz (CH)

(73) Assignee: Integra Biosciences AG, Zizers (CH)

(21) Appl. No.: 18/252,420

(22) PCT Filed: Nov. 24, 2021
(86) PCT No.: PCT/CH2021/050025

§ 371 Date: May 10, 2023

(30) Foreign Application Priority Data
Nov. 24, 2020 (CH) 01500/20

(51) Int. Cl. B01L 3/02; B01L 3/00

(52) U.S. Cl. CPC B01L 3/0237; B01L 3/0234; B01L 3/545; B01L 2200/146; B01L 2300/024; B01L 2200/026; B01L 2300/168; B01L 2300/0663

(57) ABSTRACT

The invention relates to a pipette with a first opening for receiving and removing a liquid to be dispensed and a second opening which lies opposite the first opening. According to the invention, the pipette comprises a material which causes a wavelength shift between the electromagnetic radiation absorbed by the pipette and the electromagnetic radiation emitted by the pipette. The invention additionally relates to a pipette aid for receiving a pipette for dispensing a liquid. According to the invention, the pipette aid comprises both a data storage device, in which a database with reference measurement data is stored, as well as two radiation sources and a radiation detector, wherein the two radiation sources emit electromagnetic radiation with different wavelengths, and the radiation detector detects the wavelength of the received electromagnetic radiation.

### CROSS REFERENCE TO RELATED APPLICATIONS

The present application is the U.S. national stage application of international application PCT/CH2021/050025 filed Nov. 14, 2021, which international application was published on Jun. 2, 2022 as International Publication WO 2022/109756A1. The international application claims priority to Swiss Patent Application No. 01500/20 filed Nov. 24, 2020.

### TECHNICAL FIELD OF THE INVENTION

The invention relates to a pipette according to the preamble of claim 1 and a pipetting aid according to the preamble of claim 10. The invention also relates to a method according to claim 19 and a set according to claim 21.

### BACKGROUND OF THE INVENTION

Daily laboratory work frequently involves the use of a pipette with a pipetting aid. The pipetting aid is used to generate a vacuum or pressure with which liquid is drawn into the pipette or discharged therefrom. Pipettes of different sizes are used, depending on the liquid that is to be dispensed and the application. This is because the size of the pipette affects the dispensing behavior when all other basic conditions remain the same. The basic conditions in this case are those formed by the vacuum or pressure generated by the pipetting aid.

The pipetting aid normally has a control unit in which the pressure or pressure curve that is to be set in the pipetting aid is stored. Conventional pipetting aids have an adjustment device with which the pressure is determined. The lab technician can use this adjustment device to determine the pressure in the pipetting aid. The amount of pressure depends on the pipette that is used. The pressure determines both the flow rate of the liquid as well as how long the pipetting process will take to complete. The lab technician must determine the pressure necessary in the pipetting aid on the basis of a visual assessment, and enter this in the pipetting aid using the input means for the control unit. One basis for this may be a colored labelling on the pipette. This colored labelling is normally found on the end of the pipette where it is placed in the pipetting aid. This colored labelling can be used to classify the pipettes when the same colors are used for pipettes of the same type. This tells the lab technician which setting to use on the pipetting aid.

The function of the pipetting aid described above applies to pipettes preferably used in serological studies. Pipettes can also be used that have an axial piston. The pipetting aids for these pipettes do not use pressures set in the pipetting aid to control the dispensing. Instead, the pipetting aid has a control element that moves the piston inside the pipette to control the dispensing. The piston in the pipette can be used to generate a pressure with which the liquid is dispensed. The size of the pipette and the volume that is to be dispensed must then be entered manually in the pipetting aid with an adjustment device.

### OBJECT OF THE INVENTION

One object of the invention is to create a pipette that has a label with which the pipette type is automatically identified. A pipetting aid is also proposed with which the maximum filling volume of such a pipette is automatically determined. The aim is to obtain a pipetting aid and pipette with which a pipette can be reliably and automatically identified in the pipetting aid interacting therewith. Another goal is to produce an inexpensive device with which pipettes of different volumes can be reliably identified by the control unit in the pipetting aid. Another object of the invention is to obtain a method for identifying an object, preferably a laboratory apparatus and/or its accessories.

### DESCRIPTION OF THE INVENTION

The above problems are solved with a pipette that has the features of claim 1, and with a pipetting aid that has the features of claim 10. The two devices are linked such that they solve the above problems through their interaction with one another. The devices are linked through the interactions of the radiation emitted from the pipette when it is irradiated and the subsequent detection of these radiations in the pipetting aid.

The pipette is preferably a serological pipette placed in a pipetting aid, which has a first opening for receiving and discharging a liquid, and a second opening at the opposite end. The filling volume of the pipette is between the two openings, which is encompassed by an outer surface.

The pipetting aid for receiving a pipette for dispensing a liquid comprises
a receiver with which the pipette is secured to the pipetting aid,
a control device with which liquid is received or discharged,
a handle for holding the pipetting aid,
at least one control element on the handle for controlling the receiving and discharging of the liquid, and
a control unit connected to the control element and the control device.

The technological context is expressed by the following features of both devices:
The pipette comprises a material which causes a wavelength shift between the electromagnetic radiation absorbed by the pipette and the electromagnetic radiation emitted by the pipette.
The pipetting aid has a data storage device in which a database containing reference data is stored. The pipetting aid also has two radiation sources and a radiation detector, and the two radiation sources emit electromagnetic radiation of different wavelengths, while the radiation detector detects the wavelengths of the electromagnetic radiation that it receives.

Because of the materials comprising the pipette and causing the wavelength shift between the absorbed and emitted electromagnetic radiation, the pipette can emit radiation of different wavelengths. The pipette must be irradiated with electromagnetic radiation of two different wavelengths for this. One of these wavelengths is preferably in the visible spectrum, while the other is preferably invisible to the human eye. The goal is to identify the pipette on the basis of the radiation it emits, and in particular the resulting shift in the wavelengths thereof.

The material that causes the wavelength shift of the electromagnetic radiation depends on the type of pipette. Pipettes of the same type, or same diameter and same volume, share the characteristic that the material causing the shift in wavelength is always the same. The material therefore varies from one type of pipette to another, such that when irradiated with the same electromagnetic radiation, the wavelengths are shifted to different extents, and different types of pipettes then emit electromagnetic radiation of different wavelengths. This wavelength shift of electromagnetic radiation between the absorbed and emitted radiation is known as a Stokes shift. Because of the material it is made of, a pipette according to the invention can cause a Stokes shift.

The pipetting aid has a receiver with which the pipette is held in place in the pipetting aid. The serial irradiation, i.e. the successive irradiation, of the pipette with two radiation sources, each of which irradiates the pipette with a different wavelength, results in an emission of two different wavelengths.

The radiation detector in the pipetting aid detects the electromagnetic radiation emitted from the pipette. Because radiation of two different wavelengths is emitted, the radiation detector can generate a two-symbol code. The type of pipette, including its volume, can be determined using this two-symbol code. The radiation detector stores the two-symbol code in a data storage device. The data storage device contains a database in which each two-symbol code is assigned to a specific type of pipette. The type of pipette in the receiver is determined by comparing the measurement data from the radiation detector with the data in the database. This requires that all of the different types of pipettes that are to be used must be assigned a two-symbol code that relates to the sequence of two wavelengths. As stated above, the type of pipette can also comprise information regarding the dimensions of the pipette, such as the length or filling volume. In addition to the two radiation sources and the radiation detector in the pipetting aid, the material comprising the pipette causing the wavelength shift between the electromagnetic radiation absorbed by the pipette and the electromagnetic radiation emitted therefrom is also necessary for identifying a type of pipette. In other words, the pipette must comprise a material that causes a Stokes shift in the electromagnetic radiation absorbed by the pipette. The material that causes the shift in wavelength is located in the pipette in an area that is up to 30 mm from the second opening.

This area can be in the neck of the pipette formed by the part of the outer surface that is up to 30 mm from the second opening. If the pipette has a piston, the section in which the piston is located, which is up to 30 mm from the second opening, is also in this area. The relevant part of the piston is to be determined when the piston is not extended, i.e. when the piston is in the same position it is in when the pipette is placed in the pipetting aid. Consequently, the material causing the wavelength shift is no more than 30 mm from the second opening in the pipette, as long as the piston has not moved. Because the radiation sources and the radiation detector in the pipetting aid are aimed at a limited area on the pipette, the material causing the wavelength shift only needs to be applied to this area.

Keeping the distance between the sensor in the pipetting aid and the pipette as small as possible, and minimizing external interferences will result in reliable readings by the pipetting aid. Placing the material causing the wavelength shift in the pipette where it is received in the pipetting aid does this. If the pipetting aid receives the neck of the pipette, then the neck is that area in the pipette that is closest to the pipetting aid, and for this reason should be where the material causing the wavelength shift should be located. This also practically eliminates any external effects and errors in the readings. In a preferred embodiment, the neck of a pipette cannot be seen when it is in the pipetting aid.

Improvements and/or advantageous variations on the pipette and pipetting aid are the subject matter of the dependent claims.

The pipette is preferably a serological pipette. The maximum volume of a serological pipette is 100 ml.

The difference in wavelengths between the absorbed and emitted electromagnetic radiation is preferably at least 20 nm. It is easier to see a shift if the minimum wavelength shift is at least this long.

The wavelength of the electromagnetic radiation absorbed by the pipette is preferably in a range of 100 nm to 300 nm. This range covers that from ultraviolet light to infrared light, and therefore contains both visible and invisible light waves.

In a preferred embodiment, the material causing the wavelength shift is integrated in the material that the pipette is made of. In this case, this material is distributed throughout the pipette. Consequently, the Stokes shift effect occurs at every location in the pipette.

In another preferred embodiment, the material causing the wavelength shift forms a layer applied to the pipette. By applying the material to the pipette, the material can be applied to the pipette in a separate step, after it has be manufactured. This may be a more efficient way of producing a semi-finished pipette. The material can then be applied to the pipette at specific locations, thus reducing the amount of material that is needed. Furthermore, if a pipette is mislabeled with the wrong material, it can be removed and replaced with the right material.

The material causing the wavelength shift is advantageously applied to the entire circumference of the pipette. The pipettes are rotationally symmetrical. For this reason, it is better to apply the material over the entire circumference of the pipette. This means that the pipette can be rotated in the pipetting aid without having a negative effect on the functioning of the pipette. This simplifies the job of the lab technician, because the pipette can be rotated arbitrarily inside the pipetting aid.

In another preferred embodiment, the pipette has a neck at the second end with a diameter that is less than or equal to the diameter of the outer surface of the filling volume, and the second end of the pipette is the end where the second opening is located. The neck of the pipette preferably has a diameter of 4.5 mm to 8.1 mm. The difference in the diameter of the neck to that of the outer surface depends on the diameter of the pipette. If the diameter of the pipette is already 4.5 mm to 8.1 mm at some point, it does not become smaller at the neck, because the neck has the same diameter as the rest of the cylindrical outer surface of the pipette. Even if it does not decrease in diameter, the area that is up to 30 mm from the second opening forms the neck of the pipette. The pipette is placed at its neck in a pipetting aid, such that the neck of the pipette can preferably be held in place by the pipetting aid.

The material causing the wavelength shift is advantageously applied to the neck of the pipette. The neck of the pipette is encompassed in the pipetting aid by the receiver according to the invention. In another preferred embodiment, the pipette is coated with a fluorescent material that causes the wavelength shift in the emitted radiation. A fluorescent material is a material in which the energy level of electromagnetic radiation striking and absorbed by it is greater than that of the emitted electromagnetic radiation. As a result, a fluorescent material first becomes visible, or appears to change color when it is irradiated with electromagnetic radiation.

The fluorescent material can be one of many substances with which the pipetted is made. In this case, the fluorescent material would be distributed evenly throughout the entire pipette. The fluorescent material could also be applied as a separate layer to the surface of the pipette.

In a preferred embodiment of the pipetting aid, the first radiation source is designed to emit electromagnetic radiation of a specific first wavelength, and the second radiation source is designed to emit electromagnetic radiation of a specific second wavelength. By way of example, the first radiation source can emit visible light, i.e. in a range of 380 nm to 780 nm, and the second radiation source can emit ultraviolet light, i.e. in a range of 10 nm to 410 nm, or infrared light, i.e. in a range of 750 nm to 3,000 nm. With regard to the invention, it is essential that the wavelengths of the emitted radiation differ. The shorter wavelengths of 10 nm to 410 nm form the ultraviolet spectrum, and the longer wavelengths of 750 nm to 3,000 nm form the infrared spectrum. Both ultraviolet and infrared light are invisible to the human eye. Light with wavelengths in the range of 380 nm to 780 nm forms visible light for the human eye. Irradiating material that results in a wavelength shift between the absorbed and emitted radiation can shift light that is invisible to the human eye into the visible range. To do this, the wavelengths of ultraviolet light must be increased, and that of infrared must be reduced. This can be obtained with the right materials, which are then comprised in the pipette according to the invention. An increase in the wavelengths is obtained by using a fluorescent material, and a reduction is obtained by using a material that generates a photon amplification.

The two radiation sources and the radiation detector are advantageously aimed at the receiver. The pipette is held in place in the receiver in the pipetting aid. Because the two radiation sources and the radiation detector are used to identify and classify the pipette, they must have a clear optical access to the pipette. This is why they are aimed at the receiver. All three elements are preferably aligned along the circumference, with the radiation detector between the two radiation sources. The alignment of the three elements is advantageously perpendicular to the longitudinal direction of the installed pipette.

In another preferred embodiment, the radiation detector is a color sensor. The color sensor can detect visible electromagnetic radiation, and convert the information into a digital format. The color sensor should be used if the radiation emitted by the pipette is in the visible range and can therefore be detected by the color sensor.

The pipetting aid preferably has a flow rate sensor that measures the airflow in and out of the pipette, and sends this value to the control element. Nothing but air flows through the second opening in a pipette in a pipetting aid. The first opening is used to receive and discharge liquids. The volume of the exchange through the first opening must be the same as that through the second opening, independent of the state of the medium. This means that the volume of air flowing out of the second opening must be the same as the volume of liquid flowing into the first opening in the pipette. Therefore, by measuring the volumetric flow at the second opening of the pipette, the volumetric flow at the first opening in the pipette is also determined. This is the case in both directions, such that when liquid is discharged from the pipette at the first opening, air enters the pipette at the other opening.

The volumetric flow data for the first opening can be used at any time to calculate the volume of liquid in the pipette. If the size of the pipette is known, the filling level of the pipette can be determined by determining the volume of the liquid in the pipette in relation to the overall filling volume of the pipette. By measuring the air flowing into the pipette, it is possible to determine how much liquid is flowing out of the pipette. Integrating this flow rate over time results in the overall volume of liquid that has been discharged. This makes it possible to dispense a specific amount from the pipette repeatedly.

The hydrostatic pressure in the pipette relates to the height of the liquid, and thus the filling level in the pipette. For that reason, it may be sufficient to measure the hydrostatic pressure in the pipette to determine the filling level. The pipetting aid advantageously has a pressure sensor for measuring the hydrostatic pressure in the pipette. A limit value can be defined for the hydrostatic pressure, at which point a pump in the pipetting aid shuts off, such that the pipette stops taking in any more liquid.

In another preferred embodiment, the control element has first and second buttons, the first of which is used to generate a vacuum in the pipetting aid, and the second of which is used to release this vacuum, or generate pressure in the pipetting aid. The generation of a vacuum or its release and generation of pressure has a direct effect on the aspiration or dispersion of the pipette. Using two different buttons for these functions facilitates operation of the pipetting aid by the lab technician.

The calculation of the hydrostatic pressure in the pipette depends on the angle of inclination in relation to the direction of the force of gravity. If the longitudinal axis of the pipette is parallel to the direction of the force of gravity, there is no need for a correction factor in calculating the hydrostatic pressure. If instead, the longitudinal axis of the pipette is tilted in relation to the gravitational force, a correction factor must be taken into account in calculating the hydrostatic pressure. The value of this correction factor is dependent on the angle of inclination of the pipette, which can be determined using an acceleration sensor. The pipetting aid preferably has an acceleration sensor for determining the angle of inclination of the longitudinal axis of the pipetting aid in relation to the direction of gravitational force.

Another aspect of the invention relates to a method for identifying the properties of an object specific to its type, in particular a laboratory apparatus and/or its accessories, wherein the method comprises the following steps:
irradiating an object with first electromagnetic radiation at wavelengths in a first range,
detecting the electromagnetic radiation emitted from the object with a radiation detector,
storing the wavelengths detected by the radiation detector in a temporary file,
irradiating the object with second electromagnetic radiation at wavelengths in a second range,
detecting the electromagnetic radiation emitted from the object with the radiation detector,
storing the wavelengths detected by the radiation detector in the temporary file,
comparing the wavelengths from the first and second electromagnetic radiation stored in the temporary file with wavelengths stored in a database, and
determining the properties of the object specific to its type on the basis of the comparison of the combinations of wavelengths.

The object must comprise a material that causes a wavelength shift between the electromagnetic radiation absorbed and emitted by the object. The method is characterized in that the first wavelengths lie in a range of 380 nm to 780 nm, and the second wavelengths lie in a range of 10 nm to 410 nm or 750 nm to 3,000 nm.

A laboratory apparatus is understood to be any objects suitable for use in a laboratory.

The properties specific to the type of object comprise information with which individual objects can be classified and categorized. The objects can be classified on the basis of physical and/or chemical properties, as well as properties specific to the object. Examples of physical properties are the geometric dimensions such as the nominal volumes, or mechanical properties such as the density of the material. Object-specific properties may include the processing number of the object, the production date, or the place where it was produced. The above information is an incomplete list of properties specific to a type of object.

In a preferred embodiment, the method is designed to identify a specific type of pipette 11. In this case, the object is a pipette 11. The type of pipette is determined by comparing the combination of wavelengths stored in the temporary file.

Various optional features can be used in arbitrary combinations, as long as they are not mutually exclusive. In particular where preferred ranges are specified, other preferred ranges can be obtained from combinations of the minimums and maximums specified in the ranges.

Other advantages and features of the invention can be derived from the following description of exemplary embodiments of the invention in reference to the schematic illustrations thereof in the drawings. Therein, not drawn to scale:

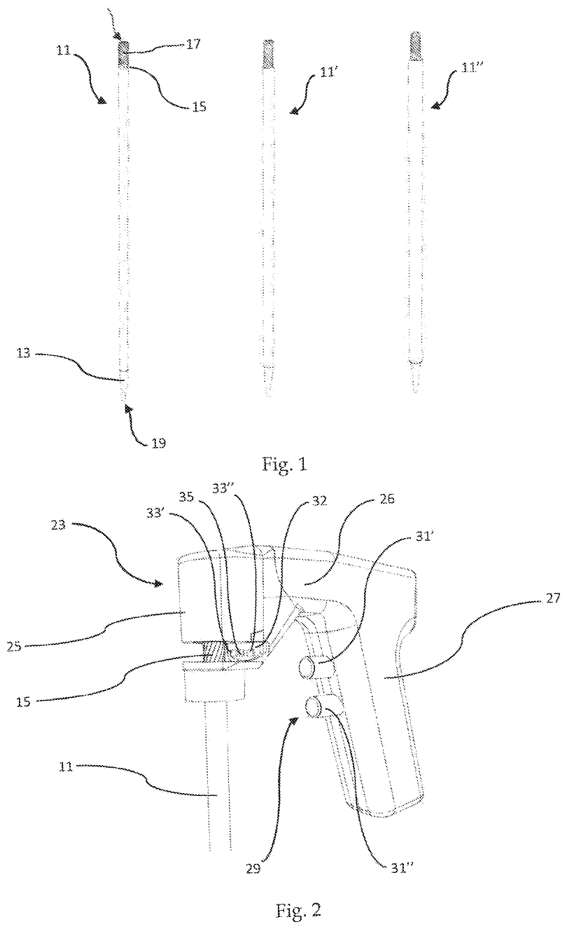

FIG. 1: shows three pipettes according to the invention, of different volumes:

FIG. 2: shows a three dimensional illustration of a pipetting aid according to the invention, with a pipette, and a partially transparent depictions showing the radiation sources and the radiation detector;

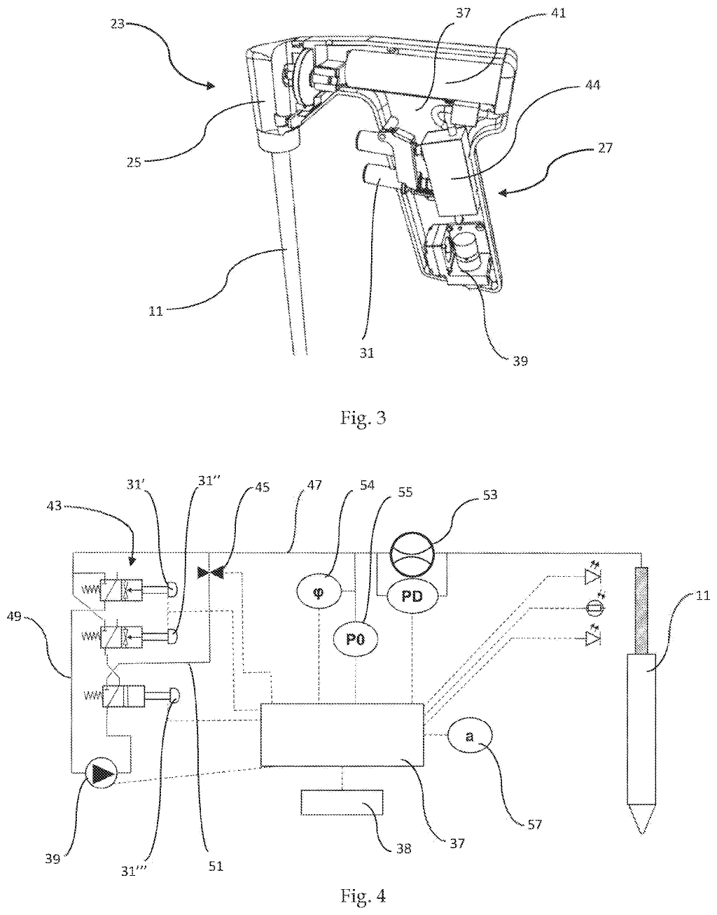

FIG. 3: shows a cross section of the pipetting aid with the components placed therein;

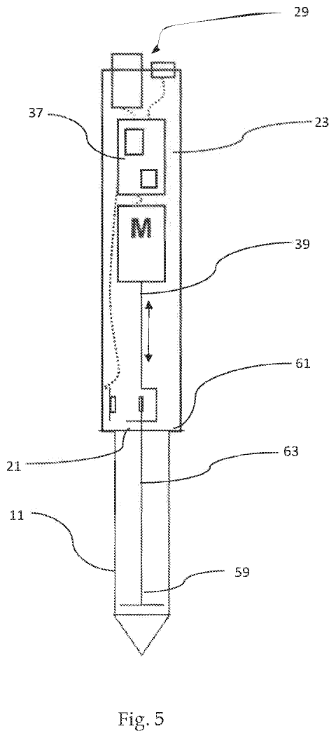

FIG. 4: shows a schematic illustration of the signal processing in the pipetting aid;

FIG. 5: shows a schematic illustration of a pipetting aid with a pipette, which contains a piston for controlling the dispensing.

### DETAILED DESCRIPTION OF THE DRAWINGS

The same reference symbols are used for identical or functionally identical elements in the following (in the different figures). An additional apostrophe may be used to distinguish similar or functionally identical, or functionally similar, elements in different embodiments.

Three pipettes 11, 11′, 11″ of different volumes are shown in FIG. 1. These pipettes are also regarded as different types of pipettes in the framework of the invention.

The pipettes 11, 11′, 11″ have a cylindrical outer surface with a conical first end forming the pipette tip 13. The neck 15 of the pipette is at the end lying opposite the pipette tip 13, which may be narrower, depending on the type of pipette. Because the pipettes 11, 11′, 11″ in FIG. 1 have different volumes, they have different diameters. The diameter of the necks 15 of the pipettes are the same, however. For this reason, the ratios of the diameters of the bodies of the pipettes to those of the necks 15 are different in these pipettes.

The pipette tip 13 has a first opening 19 at its end. This opening 19 is used to receive and discharge liquids. A second opening 21 is located at the end of the neck 15. The volumes between the first opening 19 and the second opening 21 form the filling volumes of the pipettes 11, and define the maximum amount of liquid that the pipette 11 can hold. There is a fluorescent material 17 on the neck 15 of the pipette, indicated by crosshatching.

If the pipette is not narrowed, the part of the outer surface of the pipette bordering on the second opening 21 forms the neck 15 of the pipette. This area extends to up to 30 mm from the second opening 21.

A pipetting aid 23 is shown in FIG. 2, to which a pipette 11 is attached. The pipetting aid 23 comprises a receiver 25 with which the pipette 11 is held in place. The pipetting aid 23 also has a handle 27 with a control element 29 and a mount 26. The mount 26 forms the connection between the handle 27 and the receiver 25.

The handle 27 can be held in the hand, such that the control element 29 can be operated by a second hand without any additional aids. The control element 29 has two buttons 31. The pipetting aid 23 is controlled by the two buttons 31 in that the first button 31′ is used to receive liquid in the pipette (aspiration), and the second button 31″ is used to discharge liquid from the pipette (dispensing). The pipetting aid 23 is U-shaped in the embodiment shown in FIG. 2, and the handle 27 forms one leg of the U, and the receiver 25 with the pipette 11 placed therein forms the other leg. It would also be possible for the handle 27 and the mount 26, as well as the receiver 25 and pipette 11 to be aligned along a single axis in a linear design.

The receiver 25 can preferably be removed from the mount 26 on the pipetting aid 23. This means that the receiver 25 can be removed from the rest of the pipetting aid 23 and sterilized or autoclaved separately.

The mount 26 has a dedicated sensor element 32 that comprises two radiation sources 33′, 33″ and a radiation detector 35. The sensor element 32 is placed in the mount 26 such that the radiation sources 33′, 33″ and the radiation detector are aimed at the interior of the receiver 25. A part of the receiver 25 is transparent in FIG. 2, in order to show the sensor element 32. The sensor element 32 is placed in relation to the receiver 25 such that it is aligned with the neck 15 of a pipette 11 when it is placed in the receiver. The neck 15 of the pipette is indicated by crosshatching in FIG. 2. The crosshatched area indicates the surface on the pipette 11 that has the fluorescent material.

The two radiation sources 33′, 33″ and the radiation detector 35 are adjacent to one another linearly in the sensor element 32. The radiation detector 35 is in the middle, between the two radiation sources 33′, 33″. The direction of the line on which the two radiation sources 33′, 33″ and the radiation detector lie is selected such that the axial direction of a pipette 11 installed therein is perpendicular to this line.

FIG. 3 shows a cross section of the pipetting aid 23 shown in FIG. 2. When the pipetting aid 23 is divided into the handle 27, the receiver 25, and the mount 26, most of the components of the pipetting aid 23 are located in the handle 27. The buttons 31 are each placed above a spiral spring in the handle 27 for the pipetting aid 23. The buttons 31 are in their respective inactive positions when they are pushed out as far as possible by the respective springs. Each button 31 is also connected to a needle valve 43. The needle valves 43 open and close when the respective buttons 31 are pushed. The needle valves 43 are located inside a valve block 44 and are therefore not visible in this illustration.

By operating a button 31′, 31″ and the subsequent opening of the corresponding needle valve 43, a signal is generated that is sent to the pump 39 by a control unit 37 in the pipetting aid. The pump 39 uses this signal as a start or stop signal. A hose connection is formed between the pipette 11 and the pump 39 when the needle valves 43 are opened by pushing the buttons 31′, 31″.

The handle contains a battery 41 at its upper end. The battery 41 supplies the energy necessary for all of the components in the pipetting aid 23. For this reason, the battery 41 is connected by separate wires (not shown) to the control unit 37, the pump 39 and the sensor element 32.

A schematic illustration of the hose connections 47, 49, 51 and wires between the individual components in the pipetting aid 23 is shown in FIG. 4. The pipette 11 is connected to the needle valves 43 by a first hose connection. A second hose connection 49 connects the needle valves 43 to the pump 39. Depending on the setting of the needle valves 43, the pump 39 conveys air to or from the pipette 11. The setting of the needle valves 43 and the function of the pump 39 result in the pipette 11 either receiving or discharging a liquid. The setting of the needle valves 43 is dependent on the operation of the buttons 31 in the control element 29, as explained above.

A third hose connection 51 between the pump 39 and the pipette 11 is used to bypass the needle valves 43. A control valve 45 is attached to this hose connection 51. The control valve 45 is closed if either of the needle valves 43 is open. Opening the control valve 45 triggers a discharge of the liquid in the pipette 11. The control valve 45 receives the command to open or close from the control unit 37. The operation of a button 31 in the control element 29 generates the signal for this command. The button 31 can be either of the two buttons 31′, 31″ that control the needle valves, or an additional third button 31′″. The signal from the control unit 37 to the control valve 45 opens the control valve for a limited time, even if the respective button is pushed down for longer. Successively opening control valve 45 for this limited time results in a repetitive discharge of a constant amount.

A flow rate sensor 53 is located at the first hose connection 47. The flow rate sensor 53 comprises a pressure difference sensor for measuring the flow rate in the hose connection 47 on the basis of the pressure difference detected by the sensor. There is also a pressure sensor 55 at the first hose connection 47 that measures the hydrostatic pressure in the pipette 11. A humidity sensor 54 measures the amount of liquid in the air flowing through the hose connection 47. All three sensors are connected by separate wires to the control unit 37 with which they conduct the information from their measurements to the control unit 37. The control unit 37 has a data storage device 38. All of the information from the sensors is stored therein. There is an acceleration sensor 57 in the pipetting aid 23 that is used to determine the angle of the pipette 11.

Another type of pipetting aid 23 is shown with a pipette 11 in FIG. 5, which has a piston 59 that can be moved axially. The piston in the pipette 11 generates a vacuum or pressure in the pipette 11 with which liquid is drawn into or discharged from the pipette 11. The pipette 11 has a lid 61 at its second opening 21. The lid 61 fits over the rim of the second opening 21. There is a hole in the middle of the lid through which the piston rod 63 is inserted. The pipette 11 shown in FIG. 5 is designed to be attached to a pipetting aid 23 with its lid 61.

The pipetting aid 23 in FIG. 5 has a control device 39 that moves the piston 49 in the pipette 11. This control device 39 for the pipetting aid 23 must be connected to the free end of the piston rod 63 for this when the pipette 11 is placed in the pipetting aid 23. Because the piston 59 us used to draw liquid into the pipette 11 as well as discharge it therefrom, the pipetting aid 23 does not need a pump for generating vacuum or pressure. There is also no need for hose connections and needle valves with the pipetting aid 23 for a pipette 11 shown in FIG. 5. The control element 29 is connected to the control unit 37, which receives a signal when the control element is operated, and sends a corresponding signal to the control device 39.

Both the lid 61 and the piston 59 form another part of the pipette 11 shown in FIG. 5, which can comprise a material that causes a wavelength shift between the absorbed and emitted electromagnetic radiation.

Unlike the pipette shown in FIG. 1, which has a pneumatic control system for dispensing a liquid, the pipette 11 in FIG. 5 has a mechanical control system formed by the integrated piston for the dispensing function.

Further advantages and features of the invention can be derived from the following detailed description of exemplary embodiments and/or applications of the invention.

### Further Exemplary Embodiments

The figures show exemplary embodiments of pipettes and pipetting aids according to the invention that interact to obtain an advantageous technological effect.

The same advantageous effect can also be obtained with a pipette comprising a material that is not fluorescent, but instead triggers a photon amplification. When the pipette is irradiated with infrared electromagnetic radiation, it then emits electromagnetic radiation in the visible range. Instead of a positive Stokes shift, as is the case with fluorescent material, use is made of a negative Stokes shift, in which the wavelengths of the electromagnetic radiation emitted by the pipette are shorter than those of the electromagnetic radiation it absorbs.

In the framework of the present invention, a “material that causes a wavelength shift between the electromagnetic radiation absorbed and emitted by the pipette” is understood to be organic or inorganic molecules or elements that have this property. Organic molecules that can cause photo amplification are typically polycyclic aromatic hydrocarbons (PAHs). Inorganic materials that can cause photon amplification are usually ions of those elements located in the d- or f-blocks in the periodic table. An incomplete list of these ions includes, by way of example, Ln3+, Ti2+, Ni2+, Mo3+, Re4+, and Os4+. These molecules can be integrated in the material of the pipette. This is obtained when the molecules or elements are mixed into the plastic material during the production of the pipette, e.g. in an extruder. The molecules can also be placed in a matrix and applied to pipette separately.

### Exemplary Applications

The advantages of identifying a pipette with the pipetting aid include being able to determine the filling volume of the pipette in the pipetting aid.

This advantage enables, among others, the use of the following three functions of the pipetting aid:

### Protection Against Overfilling

The pipetting aid has a flow rate sensor that measures the volumetric flow of air in the hose connection. Because the air in the hose connection is not substantially compressed, or does not experience any change in density, the volumetric flow of the air in the hose connection is basically equal to the volumetric flow of the liquid in the pipette. This means that the volume of air conveyed by the pump in the hose connection is basically the same as the volume of liquid drawn into the pipette. To make any corrections to the volumetric flow of the air, additional humidity sensors, inclination sensors, hydrostatic pressure sensors, etc. can be placed in the pipetting aid. By integrating the measured volumetric flow, it is possible to determine how much liquid has been conveyed. This amount must not exceed a previously determined filling amount for the pipette. The filling amount for the pipette is based on its volume. When the pipette is identified by the pipetting aid, it obtains the information regarding the pipette filling volume. The pipetting aid can then stop drawing liquid into the pipette when it reaches its filling volume. This prevents any overfilling of the pipette, and the lab technician can fill the pipette without having to constantly monitor the filling process.

### Pressure Adjustment in the Pipetting Aid

Another advantage obtained by identifying the pipette with the pipetting aid is the adjustment of the pressure in the pipetting aid. The pressure in the pipetting aid affects the pipetting speed. When the difference between the ambient pressure and the pressure in the pipetting aid is higher, the pipetting speed is higher. Because the dimensions of the pipettes vary significantly, a higher pipetting speed in a small pipette can result in imprecision. This requires a quick reaction to the changes in small pipettes on the part of the lab technician, which may be difficult at high pipetting speeds. For this reason, the pipetting aid can adjust the pressure to the pipette therein such that the pipetting speed remains within a comfortable range for the lab technician.

### Repeated Discharge:

The pipette is used to receive and discharge a liquid. This often involves a uniform dispensing of the liquid in small amounts. The pipetting aid can include a function for this, with which a predetermined amount can be discharged. This function can be repeated successively in order to dispense the same amount repetitively. The amount of liquid that is dispensed must or can be set by the user. There is a hose connection in the pipetting aid for this repetitive discharge, which bypasses the needle valves. A control valve is connected to this hose connection. The opening of the control valve reduces the vacuum in the hose connection, which, with the operation of the pump, results in discharging the liquid in the pipette. The amount of liquid discharged by the pipette corresponds to the amount of air that flows into the pipette through the hose connection. This airflow is determined simultaneously by the flow rate sensor. The integration of the flow rate speed results in the overall amount that is conveyed, as explained above. When the amount that is to be dispensed has been reached, the control valve is automatically closed by the pipetting aid, and the discharge of liquid in the pipette is stopped. The control valve can then be reopened for the subsequent dispensing, and then be closed again, after discharging the amount that is to be dispensed. The point in time at which the control valve is opened is determined by the user. There can be another button on the control element for this, with which the control valve is opened. It is also conceivable to modify one of the two buttons in the control element with which the needle valves are controlled, such that this modified button can be used to open the control valve. The modification of the button can allow the button to be rotated about its cylindrical axis for example.

Although specific embodiments have been described above, it is clear that different combinations of these possible embodiments can be used, as long as these possibilities are not mutually exclusive.

### LIST OF REFERENCE SYMBOLS

11 pipette
13 tip of the pipette (conical tapering)
15 abrupt narrowing
17 fluorescent material
19 first opening in the pipette
21 second opening in the pipette
23 pipetting aid
25 receiver
26 mount
27 handle
29 control element
31 button
32 sensor element
33 radiation source
35 radiation detector
37 control unit
38 data storage device
39 operating device/pump
41 battery
43 needle valve
44 valve block
45 control valve
47 first hose connection
49 second hose connection
51 third hose connection
53 flow rate sensor
54 humidity sensor
55 pressure sensor
57 acceleration sensor
59 piston
61 lid
63 piston rod

1. A pipette (11), preferably for use with a pipetting aid (23), which has a first opening (19) for receiving and discharging a liquid that is to be dispensed, and a second opening (21) at the end opposite the first opening, wherein the pipette (11) has a filling volume between the two openings (19, 21) and an outer surface that encompasses the filling volume, characterized in that the pipette (11) comprises a material (17) that causes a wavelength shift between the electromagnetic radiation absorbed and emitted by the pipette (11), and that the material (17) causing the wavelength shift is located in a part of the pipette up to 30 mm from the second opening.

2. The pipette (11) according to claim 1, wherein the difference in the wavelengths between the electromagnetic radiation absorbed and emitted by the pipette (11) is at least 20 nm.

3. The pipette (11) according to claim 1, wherein the electromagnetic radiation absorbed by the pipette (11) has a wavelength of 100 nm to 3,000 nm.

4. The pipette (11) according to claim 1, wherein the material (17) causing the wavelength shift is integrated in the material of the pipette (11).

5. The pipette (11) according to claim 1, wherein the material (17) causing the wavelength shift is in a layer applied to the pipette (11).

6. The pipette (11) according to claim 1, wherein the material (17) causing the wavelength shift is applied to the entire circumference of the pipette.

7. The pipette (11) according to claim 1, wherein the pipette (11) has a neck (15) on the end where the second opening (21) is, wherein the diameter of the neck is smaller than or equal to the diameter of the outer surface of the filling volume.

8. The pipette according to claim 7, wherein the material (17) causing the wavelength shift is on the neck (15) of the pipette (11).

9. The pipette (11) according to claim 1, wherein pipette (11) comprises a fluorescent material (17) that causes the wavelength shift in the emitted radiation.

10. A pipetting aid (23) for receiving a pipette (11) for dispensing a liquid, comprising
a receiver (25) for securing the pipette (11) in the pipetting aid (23),
a control device (39) for receiving or discharging the liquid,
a handle (27) for holding the pipetting aid (23),
at least one control element (29) for controlling the receiving and discharging of the liquid,
a control unit (37) that is connected to the control element (29) and the control device (39),
wherein
the pipetting aid (23) comprises a data storage device (38) in which a database with reference measurement data is stored, and
the pipetting aid (23) has two radiation sources (33) and a radiation detector (35), wherein the two radiation sources (33) emit electromagnetic radiation with different wavelengths, and the radiation detector (35) detects the wavelengths of the electromagnetic radiation it receives.

11. The pipetting aid (23) according to claim 10, wherein the first radiation source is designed to emit electromagnetic radiation with a wavelength of 380 nm to 780 nm, and the second radiation source is designed to emit electromagnetic radiation with a wavelength of 10 nm to 410 nm, or 750 nm to 3,000 nm.

12. The pipetting aid (23) according to claim 10, or 11, wherein the two radiation sources (33) and the radiation detector (35) in the pipetting aid (23) are aimed at the receiver (25).

13. The pipetting aid (23) according to claim 10, wherein the radiation detector (35) is a color sensor.

14. The pipetting aid (23) according to claim 10, wherein the control device (39) comprises a pump with which a pressure is generated in the pipetting aid (23) for receiving and discharging the liquid.

15. The pipetting aid (23) according to claim 10, wherein the pipetting aid (23) has a flow rate sensor (53) that measures the flow rate of the air in and out of the pipette (11), and sends this value to the control unit (37).

16. The pipetting aid (23) according to claim 10, wherein the pipetting aid (23) has a pressure sensor (55) for measuring the hydrostatic pressure in the pipette (11).

17. The pipetting aid (23) according to claim 10, wherein the control element (29) has a first and second button (31′, 31″), wherein pushing the first button (31′) generates a vacuum in the pipetting aid (23) and pushing the second button (31″) releases this vacuum or generates a pressure in the pipetting aid (23).

18. The pipetting aid (23) according to claim 10, wherein the pipetting aid (23) has an acceleration sensor (57) for determining the angle of inclination of the longitudinal axis of the pipetting aid (23) in relation to the direction of the force of gravity.

19. A method for identifying a property of an object specific to its type, in particular a laboratory apparatus and/or its accessories, through the following steps:
irradiating the object with first electromagnetic radiation at wavelengths in a first range,
detecting the electromagnetic radiation emitted from the object with a radiation detector (35),
storing the wavelengths detected by the radiation detector (35) in a temporary file,
irradiating the object with electromagnetic radiation at wavelengths in a second range,
detecting the electromagnetic radiation emitted from the object with the radiation detector (35),
storing the wavelengths detected by the radiation detector (35) in the temporary file,
comparing the wavelengths from the first and second electromagnetic radiation stored in the temporary file with wavelengths stored in a database (38),
determining the property of the object specific to its type on the basis of the comparison of the wavelength combinations,
wherein the object comprises a material (17) that causes a wavelength shift between the electromagnetic radiation absorbed and emitted by the object, and the wavelengths in the first range lie between 380 nm and 780 nm and the wavelengths in the second range lie between 10 nm and 410 nm or between 750 nm and 3,000 nm.

20. The method according to claim 19, wherein the object is a pipette (11) and the method is for identifying a specific type of pipette.

21. A set containing a pipette according to claim 1, and a pipetting aid according to any of the claims 10 to 18.
